(19) United States
(12) Patent Application Publication
(10) Pub. No.: US 2023/0287284 A1
(43) Pub. Date: Sep. 14, 2023

(54) Systems and Methods for Producing a Decarbonized Blue Hydrogen Gas for Cracking Operations

(71) Applicant: Bechtel Energy Technologies & Solutions, Inc., Houston, TX (US)

(72) Inventor: Thomas M. Jones, Sugar Land, TX (US)

(73) Assignee: Bechtel Energy Technologies & Solutions, Inc., Houston, TX (US)

(21) Appl. No.: 18/033,618

(22) PCT Filed: Aug. 22, 2022
(86) PCT No.: PCT/US22/41049

§ 371 Date: Apr. 25, 2023

Related U.S. Application Data
(60) Provisional application No. 63/239,844, filed on Sep. 1, 2021.

(51) Int. Cl. C10G 70/04; C01B 3/24; C10G 9/36

(52) U.S. Cl. CPC C10G 70/046; C01B 3/24; C10G 9/36; C10G 2400/20; C10G 2300/4043; C01B 2203/063; C01B 2203/84

(57) ABSTRACT

Systems and methods for producing a decarbonized blue hydrogen gas for cracking operations utilizing a standard separation process, such as Pressure Swing Absorption (PSA), to separate a tail gas mixture of hydrogen and hydrocarbons into hydrogen gas and a PSA effluent that is used in a hydrogen generation unit to produce the decarbonized blue hydrogen gas for cracking operations

### CROSS-REFERENCE TO RELATED APPLICATIONS

This application claims priority to U.S. Provisional Application No. 63/239,844, filed Sep. 1, 2021, which is incorporated herein by reference.

### FIELD OF THE DISCLOSURE

The present disclosure generally relates to systems and methods for producing a decarbonized blue hydrogen gas for cracking operations. More particularly, the disclosed systems and methods utilize a standard separation process, such as Pressure Swing Absorption (PSA), to separate a tail gas mixture of hydrogen and hydrocarbons into hydrogen gas and a PSA effluent that is used in a hydrogen generation unit to produce the decarbonized blue hydrogen gas for cracking operations.

### BACKGROUND

Cracking is a process in which hydrocarbon molecules in the presence of steam are converted into molecules with a carbon-carbon double bond such as, for example, ethylene, that may be used to make petrochemical products such as polyethylene. Steam cracking operations typically use tail gas, which is a mixture of hydrogen and hydrocarbons (e.g., methane and/or ethane) generated in the process, to provide the fuel necessary for steam cracking and vreating the energy intensive carbob-carbon double bond. The process of heating or firing the hydrocarbons in a cracking furnace generates carbon dioxide (CO2) and other greenhouse gases that are emitted to the atmosphere.

FIG. 1 illustrates this process in a conventional ethylene production system 100. A hydrocarbon feedstock stream 102 is processed in a steam cracking furnace 104 that is heated (fired) using a tail gas stream 106 as fuel, which may be a mixture of hydrogen (H2) and hydrocarbons (CH4). The normal fuel for an ethylene cracking furnace is a hydrogen rich tail gas byproduct that has a high mass content of methane or other hydrocarbons, which generate CO2 in the cracking furnace. The tail gas can contain as much as 75% to 80% by volume hydrogen with the remainder mostly methane. For some feedstocks the hydrogen concentration in the tail gas is as low as 5% to 10% by volume.

The cracked hydrocarbon feedstock stream 108 is sent to a separations train 110, which separates the cracked hydrocarbon feedstock stream 108 into the tail gas stream 106, an ethylene stream 112 and other byproducts 114, which may include propylene, a liquified petroleum gas (LPG) and natural gas liquids (NGL). The use of known separation techniques such as PSA, polymeric separation membranes, and even cryogenic distillation may be employed by the separations train 110 although PSA is the preferred separation technique used in ethylene production systems. The emissions 116 from the steam cracking furnace 104 contain CO2 due to hydrocarbon combustion and water vapor (H20). Due to increasing environmental concerns and operating restrictions on carbon emissions, many petrochemical companies are compelled to reduce the carbon emissions from their current steam cracking operations.

### BRIEF DESCRIPTION OF THE DRAWINGS

The detailed description is described below with reference to the accompanying drawings, in which like elements are referenced with like reference numbers, in which:

FIG. 1 is a schematic diagram illustrating a conventional ethylene production system.

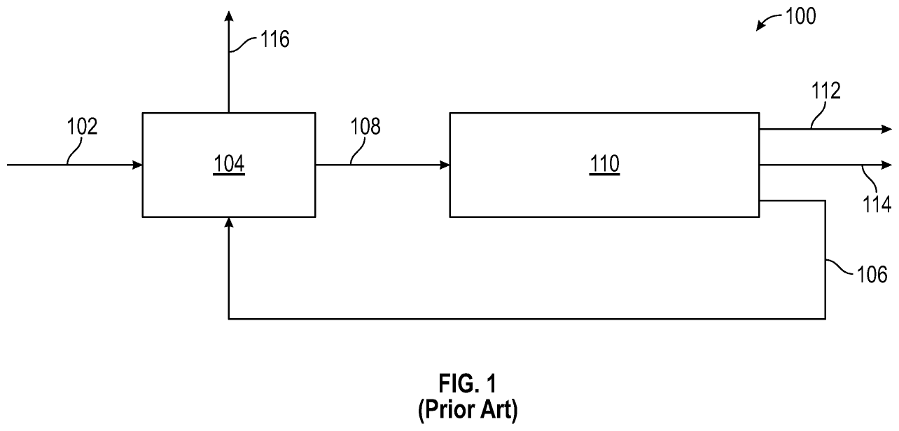

FIG. 2 is a schematic diagram illustrating one embodiment of a modified ethylene production system.

FIG. 3 is a schematic diagram illustrating another embodiment of a modified ethylene production system.

### DETAILED DESCRIPTION OF THE ILLUSTRATIVE EMBODIMENTS

The subject matter of the present disclosure is described with specificity, however, the description itself is not intended to limit the scope of the disclosure. The subject matter thus, might also be embodied in other ways, to include different structures, steps and/or combinations similar to and/or fewer than those described herein, in conjunction with other present or future technologies. Although the term “step” may be used herein to describe different elements of methods employed, the term should not be interpreted as implying any particular order among or between various steps herein disclosed unless otherwise expressly limited by the description to a particular order. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures and dimensions described herein are only exemplary and are not intended to assert or imply any limitation with regard to the environment, architecture, design, or process in which different embodiments may be implemented. To the extent that temperatures and pressures are referenced in the following description, those conditions are merely illustrative and are not meant to limit the disclosure.

The systems and methods disclosed herein reduce the carbon emissions from steam cracking operations by separating a tail gas mixture of hydrogen and hydrocarbons into hydrogen gas and a PSA effluent, which is used in a hydrogen generation unit intended to produce a decarbonized blue hydrogen gas for the steam cracking operations. The hydrogen generation unit may thus, include steam methane reforming, auto thermal reforming, and partial oxidation.

In one embodiment, the present disclosure includes a system for producing a decarbonized blue hydrogen gas stream for cracking operations, which comprises: i) a cracking furnace comprising a hydrocarbon feedstock and a decarbonized blue hydrogen gas from the decarbonized blue hydrogen gas stream for producing a cracked hydrocarbon feedstock stream and emissions comprising water vapor and residual carbon dioxide; ii) a separations train for separating the cracked hydrocarbon feedstock stream into a tail gas stream and a product stream; iii) a separation system for separating the tail gas stream into a hydrogen gas stream and an effluent stream; and iv) a hydrogen generation unit for processing the effluent stream and producing the decarbonized blue hydrogen gas stream and carbon dioxide emissions.

In another embodiment, the present disclosure includes a method for producing a decarbonized blue hydrogen gas stream for cracking operations, which comprises: i) cracking a hydrocarbon feedstock using the decarbonized blue hydrogen gas stream to produce a cracked hydrocarbon feedstock stream and emissions comprising water vapor and residual carbon dioxide; ii) separating the cracked hydrocarbon feedstock stream into a tail gas stream and a product stream; iii) separating the tail gas stream into a hydrogen gas stream and an effluent stream; and iv) processing the effluent stream to produce the decarbonized blue hydrogen gas stream and carbon dioxide emissions.

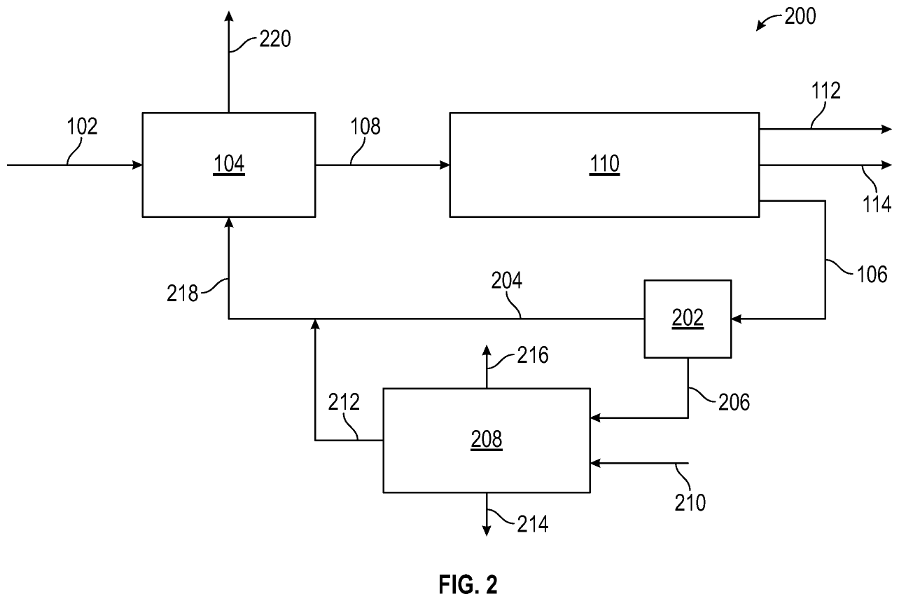

Referring now to FIG. 2, a schematic diagram illustrates one embodiment of a modified ethylene production system 200. The tail gas stream 106 is fed through a hydrogen/hydrocarbon separation system (e.g., PSA) 202, which separates the tail gas stream 106 into a hydrogen gas stream (H2) 204 with a high purity of greater than 98% by volume and a PSA effluent stream 206 comprising hydrocarbons (CH4) and residual hydrogen gas. The PSA effluent stream 206 is fed to a hydrogen generation unit 208, which may be integrated with a supplemental fuel gas stream 210 comprising make-up natural gas supplied from a pipeline or other source to operate the blue hydrogen unit 208.

The hydrogen generation unit 208 produces a decarbonized blue hydrogen gas stream 212, a byproduct 214 comprising methane, carbon monoxide, water, unrecovered hydrogen, unrecovered CO2, and inert gases, and CO2 emissions 216, which may be captured and compressed for sequestration and storage. The blue hydrogen gas stream 212 may be combined with the hydrogen gas stream 204 to form a hydrogen fuel gas stream 218 that is used to heat (fire) the steam cracking furnace 104. The supplemental fuel gas stream 210 may be adjusted to balance the total requirements of the steam cracking furnace 104. The hydrogen fuel gas stream 218 may also be supplemented with the tail gas stream 106 for steam cracking furnaces that cannot fire 100% hydrogen fuel.

The emissions 220 from the steam cracking furnace 104 contain water vapor (H20) and trace levels of residual CO2 emissions. In this manner, hydrocarbons are converted into hydrogen to consume the byproduct fuel and capture the CO2 (pre-combustion) so that it is not emitted to the atmosphere.

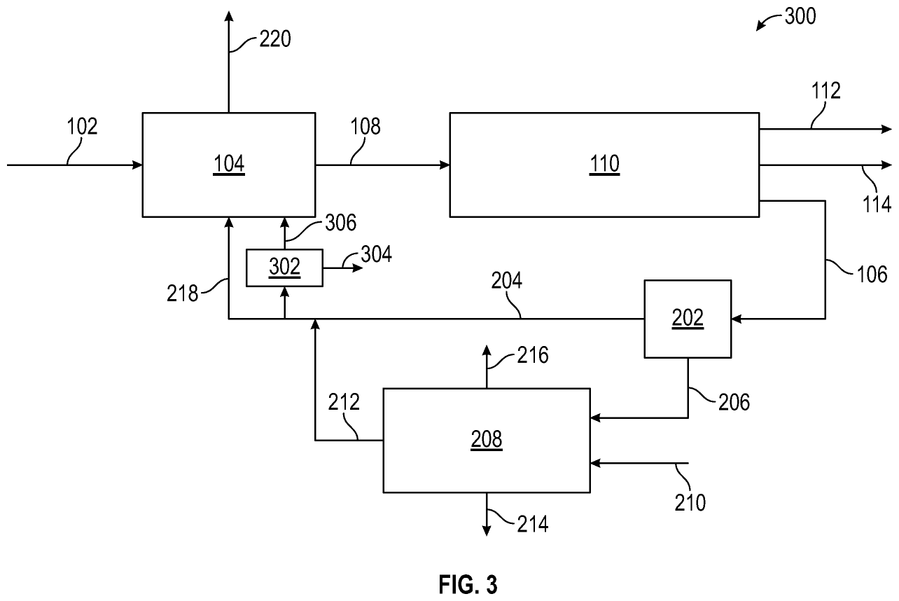

Referring now to FIG. 3, a schematic diagram illustrates another embodiment of a modified ethylene production system 300. The hydrogen fuel gas stream 218 may also be sent to a gas turbine generator 302 in which the exhaust stream 306 is integrated into the steam cracking furnace 104 as air preheat, which produces an electrical power output 304 and reduces the overall energy required (specific energy content) to produce a unit mass of ethylene.

The systems and methods disclosed herein define a unique way to use the existing source of tail gas combined with a hydrogen generation unit to economically produce the total hydrogen cracker fuel requirement from clean burning hydrogen. The uniqueness of this approach is that the energy value of the separated methane is retained by chemical transformation into clean burning hydrogen, which is then combined with the initially separated hydrogen. Any excess hydrogen produced from the tail gas can be fed to a combined cycle gas turbine or offsite boiler to generate power/steam with reduced emissions and can use a gas turbine generator integrated into the cracking furnaces to enhance the energy required to produce a unit mass of ethylene. The systems and methods, therefore, may be employed in combined cycle power plants that are installed in several petrochemical complexes by converting natural gas feed into blue hydrogen gas that only emits water vapor when combusted.

Because it is more economical to remove pre-combustion CO2 from a process stream compared to post-combustion CO2, the system and methods disclosed herein present decarbonizing opportunities for existing operations at multiple petrochemical sites around the world. There is over 150 million tons of ethylene produced globally so potentially over 100 million tons of ethylene cracking furnace CO2 emissions can be eliminated by precombustion capturing of CO2 via conversion of hydrocarbon-based fuel in hydrogen generation units.

While the present disclosure has been described in connection with presently preferred embodiments, it will be understood by those skilled in the art that it is not intended to limit the disclosure of those embodiments. The system and methods, for example, may be applied to various cracking operations where a product other than, or in addition to, ethylene is produced. It is therefore, contemplated that various alternative embodiments and modifications may be made to the disclosed embodiments without departing from the spirit and scope of the appended claims and equivalents thereof.

1. A system for producing a decarbonized blue hydrogen gas stream for cracking operations, which comprises:
a cracking furnace comprising a hydrocarbon feedstock and a decarbonized blue hydrogen gas from the decarbonized blue hydrogen gas stream for producing a cracked hydrocarbon feedstock stream and emissions comprising water vapor and residual carbon dioxide;
a separations train for separating the cracked hydrocarbon feedstock stream into a tail gas stream and a product stream;
a separation system for separating the tail gas stream into a hydrogen gas stream and an effluent stream; and
a hydrogen generation unit for processing the effluent stream and producing the decarbonized blue hydrogen gas stream and carbon dioxide emissions.

2. The system of claim 1, wherein the separations train is configured to separate the cracked hydrogen feedstock stream using pressure swing absorption, polymeric separation membranes or cryogenic distillation.

3. The system of claim 1, wherein the separation system is configured to separate the tail gas stream using pressure swing absorption.

4. The system of claim 1, wherein the hydrogen generation unit is configured to process the effluent stream using steam methane reforming, auto-thermal reforming or partial oxidation.

5. The system of claim 1, wherein the effluent stream comprises hydrocarbons and residual hydrogen gas.

6. The system of claim 1, wherein the cracking furnace emissions include less carbon dioxide than the carbon dioxide emissions from the hydrogen generation unit.

7. The system of claim 1, further comprising a supplemental fuel gas stream comprising natural gas connected to the hydrogen generation unit.

8. The system of claim 1, wherein the decarbonized blue hydrogen gas stream and the hydrogen gas stream are connected to form a hydrogen fuel gas stream connected to the cracking furnace.

9. The system of claim 8, further comprising a gas turbine generator connected to the hydrogen fuel gas stream and the cracking furnace for producing an electrical power output.

10. The system of claim 1, wherein the product stream comprises ethylene.

11. A method for producing a decarbonized blue hydrogen gas stream for cracking operations, which comprises:
cracking a hydrocarbon feedstock using the decarbonized blue hydrogen gas stream to produce a cracked hydrocarbon feedstock stream and emissions comprising water vapor and residual carbon dioxide;
separating the cracked hydrocarbon feedstock stream into a tail gas stream and a product stream;
separating the tail gas stream into a hydrogen gas stream and an effluent stream; and
processing the effluent stream to produce the decarbonized blue hydrogen gas stream and carbon dioxide emissions.

12. The method of claim 11, wherein the cracked hydrocarbon feedstock stream is separated using pressure swing absorption, polymeric separation or cryogenic distillation.

13. The method of claim 11, wherein the tail gas stream is separated using pressure swing absorption.

14. The method of claim 11, wherein the effluent stream is processed using steam methane reforming, auto-thermal reforming or partial oxidation.

15. The method of claim 11, wherein the effluent stream comprises hydrocarbons and residual hydrogen gas.

16. The method of claim 11, wherein the emissions from cracking the hydrocarbon feedstock include less carbon dioxide than the carbon dioxide emissions from processing the effluent stream.

17. The method of claim 11, further comprising adjusting a supplemental fuel gas stream used to process the effluent stream and balance predetermined requirements for the cracked hydrocarbon feedstock stream.

18. The method of claim 11, further comprising combing the decarbonized blue hydrogen gas stream and the hydrogen gas stream to form a hydrogen fuel gas stream used for cracking the hydrocarbon feedstock.

19. The method of claim 18, further comprising using the hydrogen fuel gas stream to operate a gas turbine generation and produce an electrical output.

20. The system of claim 11, wherein the product stream comprises ethylene.
